(19) United States
(12) Patent Application Publication
(10) Pub. No.: US 2007/0124943 A1
(43) Pub. Date: Jun. 7, 2007

(54) Method for feeding a child during the child's transition from bottle- to spoon-feeding

(76) Inventor: Donna Hougland, Portland, OR (US)

Correspondence Address: Oppedahl Patent Law Firm LLC, P.O. BOX 4850, FRISCO, CO, 80443-4850, US

(21) Appl. No.: 11/548,284

(22) Filed: Oct. 11, 2006

Related U.S. Application Data
(63) Continuation of application No. 10/671,178, filed on Sep. 25, 2003.

(51) Int. Cl. A47J 43/28

(52) U.S. Cl. 30/324

(57) ABSTRACT

A method for feeding a child, the child having a mouth, the child having a transition from bottle-to spoon-feeding, the child having a natural swallowing reflex, the method for use during that transition, the method with respect to a spoon having a handle a bowl, the bowl having an end away from the handle thus defining an anterior end, the bowl having an end toward the handle thus defining a posterior end, the method comprising the steps of: covering a front portion of a spoon bowl by an enclosing shield so that that it leaves an opening at a posterior of the spoon bowl and at an anterior of the spoon bowl. The method also includes a step of collecting a semi-liquid food through the posterior opening in the spoon bowl by moving the spoon bowl through a container of food so that the semi-liquid food enters the posterior opening of the spoon bowl and is held within a bowl cavity formed by the spoon bowl and the enclosing shield. The method also includes a step of inserting the spoon into the child's mouth. Another step of the method is suctioning the semi-liquid food by the child through the anterior opening of the spoon bowl and into a rear cavity of the child's mouth. The last step of the method is removing the spoon form the child's mouth to allow for the natural swallowing reflex to be completed.

### CROSS-REFERENCE TO RELATED APPLICATIONS

This application claims priority from U.S. application Ser. No. 10/671,178 filed Sep. 25, 2003, and published as US 20050066531 on Mar. 31, 2005, which application is hereby incorporated herein by reference for all purposes.

### FIELD OF THE INVENTION

The present invention relates generally to a method involving a feeding utensil for a person who has difficulty feeding from a spoon, and specifically to a utensil that is particularly designed to improve feeding efficiency and comfort for infants, children, and other persons who are learning to feed using utensils after being bottle-fed.

### BACKGROUND

In the prior art, the utensils used during an infant's transition from feeding by bottles to feeding by utensils have been common table spoons or variations on said spoons. These spoons have served as rudimentary means of conveyances for the introductory, semi-liquid infant foods usually offered to infants. While some variations in the shape of the bowl or the handle, or in the function of the handle, have been taught in the prior art, none deals effectively with the problem of food being forced back out of the child's mouth during the transition training process.

The problem inherent in transitional feeding arises because of the way in which infants learn to swallow. Before learning to use a utensil, a child swallows by natural feeding reflex, or suction. When a spoon or other utensil is first inserted into a child's mouth, the child closes his or her lips around the utensil and the child's tongue attempts to achieve the reflex or suction action. The tongue moves forward and upward because it is that action that is used to press a nipple against the alveolar ridge in the top of the mouth to suck fluid. With the spoon, however, this tongue action results in expulsion of the food as the utensil is drawn out of the mouth. Without a complete seal of the lips around the utensil, the tongue is unable to draw food into the oral cavity.

Another problem in transitional feeding has not been addressed by any known prior art. With the repeated introduction of a spoon into a child's mouth, eventually the child will suck some of the food into its mouth and swallow. However, the repeated introduction of the spoon into the child's mouth causes the child to ingest air with the food, resulting in impeded digestion, regurgitation, and even painful intestinal gas.

U.S. Pat. No. 6,404,838 teaches a measuring spoon with an integral counting dial, a retractable lid that serves to level the amount of food or liquid held in the spoon, and a visual display scale. This fairly complex measuring spoon is intended as a dispensing device during food preparation, and it would be a complicated and difficult means for directly introducing food or liquid into a child's mouth.

U.S. Pat. No. 5,946,807 teaches a novelty spoon-and-straw combined device, which can be used as a spoon from one end and turned around and used as a straw from the other end. This device does not assist a child with learning to eat from a utensil, but simply serves as a spoon or as a straw at the option of the user.

U.S. Pat. No. 6,347,727 teaches a feeding system that can be used with one hand to feed an infant, leaving the other hand free. The feeding system consists of the bowl of a spoon attached to a shortened handle with a tube inside it, which in turn is attached to a tube of baby food held on a rigid surface and emptied into the spoon by means of rolling compression mechanism that squeezes the tube.

None of the prior art has resolved the problems inherent in transitional feeding, and there remains a need for an improved utensil that minimizes the introduction of air into the mouth and esophagus of a child and increases the comfort and efficiency of feeding.

### SUMMARY OF THE INVENTION

The present invention relates to a utensil that functions in a novel way, as compared to an open feeding spoon during a child's transition from bottle- to spoon-feeding. Said utensil is comprised of a spoon having an enclosing shield that partially encloses the bowl, a large opening at the posterior end of the bowl, a smaller opening at the anterior end of the bowl, and a contoured handle.

It is desirable to provide a utensil that is of an inexpensive and uncomplicated design. The present invention employs a utensil that is designed for inexpensive manufacture and easy use by consumers, without complicated instructions or part assembly. The simplicity of the utensil of the present invention allows it to be easily provided in various sizes for different ages and mouth sizes. A preferred size for infants is a spoon bowl that holds from 6 to 15 milliliters of the semi-liquid food, medicine, or other nutrient being fed. The utensil of the present invention can be manufactured in certain sizes for the administration of specific dosages of medicine.

It is also desirable is to provide a utensil that is safe for an infant. The bowl of the spoon in the present invention may be made of materials, or coated for durability with materials, that can be repeatedly sterilized without breaking down, or for safety it may be comprised of or coated with materials that are heat-resistant or that change color when exposed to heat so as to indicate a high temperature. The entire utensil is a single integral piece for safety during the feeding process, preventing separation of small parts that could be swallowed.

It is also desirable to provide a utensil that increases feeding efficiency and reduces expulsion of food from the mouth during an infant's transitional feeding stage from bottle to spoon. In the utensil of the present invention, semi-liquid food is collected into the larger opening at the posterior of the spoon bowl by drawing the spoon through food in a dish or jar. The posterior opening is specially configured in a spatula-like shape for guiding food into the opening and making collection of the food easier. The front portion of the spoon bowl covered by the enclosing shield is then placed into the child's mouth, providing full circumferential contact with the child's mouth. In other words, as the child closes its lips around the front part of the spoon bowl and enclosing shield, complete contact is achieved between said utensil and both the upper and lower lips, creating a seal around the anterior opening of the utensil. The anterior of the spoon is specifically shaped as a depressed nipple. Its function relies on the infant's ability to begin the swallow by controlling the tongue and lips, forcing food to enter through the small opening created by the tongue and lips. When the seal on the anterior of the spoon bowl is in effect, the natural upward and forward movement of the child's tongue works to reduce air pressure within the oral cavity, thereby drawing the semi-liquid food from within the unpressurized cavity of the utensil into the rear of the child's mouth cavity. Thus, the food is released from the spoon into the rear of the child's mouth as the child engages in the natural feeding reflex, or suction. As the food is being moved into the back of the mouth, the child's lips remain sealed on the spoon bowl and enclosing shield. The spoon can then be removed from the mouth because the food has already been enveloped by the tongue and swept to the rear of the child's mouth, reducing and even eliminating the expulsion of food from the mouth. With the spoon removed, the child's mandible is able to close so as to complete the natural swallowing reflex.

It is also desirable to reduce air intake during the feeding process. Once a child sucks the food into the oral cavity, the spoon can be removed because the food is in the rear of the child's mouth cavity. The child can then complete the natural swallowing reflex by closing the mandible, sealing of the pharynx, and protecting the trachea. Because the spoon has been removed at this point, the swallowing action is completed without the introduction of air at the front of the oral cavity. The utensil of the present invention eliminates the need for repeated introduction of the spoon into the child's mouth to prevent expulsion of the food or to assist the child to move the food into the rear of the mouth cavity. In the absence of excess air, the food moves smoothly past the epiglottis and through the cricopharyngeal sphincter into the esophagus. The result is that less air is introduced into the digestive tract, reducing the occurrence of gastroesophageal reflux and gastrointestinal distress.

It is also desirable to provide a spoon that facilitates the feeding process. For this reason, the handle of the utensil of the present invention has been specially designed with a diagonal ridge to facilitate gripping it with the thumb and forefinger, such that the side of each digit is placed against opposing sides of the ridge. In addition, the anterior edge of the spoon is designed with a straight edge for easier collection of food that misses the infant's mouth during the feeding process. A straight edge at the anterior tip of the spoon has been shown in development to be more useful in scraping food off of an infant's face.

### BRIEF DESCRIPTION OF THE DRAWINGS

FIG. 1 shows a top view of a utensil for use with the present invention, showing the top surface of the handle and the enclosing shield on the spoon bowl.

FIG. 2 shows a side view of the utensil for use with the present invention, showing the enclosing shield on the spoon bowl and the contoured handle.

FIG. 3 shows a cross-sectional view of an infant while utensil of the present invention is in use.

FIG. 4 shows the spoon from the point of view of the person being fed.

FIG. 5 shows the spoon from the point of view of the person doing the feeding.

FIG. 6 shows a side view of the spoon, from the opposite side as that shown in FIG. 2.

FIG. 7 shows a bottom view of the spoon.

Where possible, like reference designations have been employed for like elements among the figures.

### DESCRIPTION OF EXEMPLARY EMBODIMENTS

This invention consists of the use of a utensil that encourages the transition from bottle-feeding to spoon-feeding by utilizing a person's natural feeding reflex, resulting in feeding that is improved in terms of efficiency, reduced air-intake, and comfort.

While this application is written with emphasis on infants, this is merely for ease of reference. It should be noted that the present invention is not limited to use with children. Any person who has difficulty ingesting a semi-liquid food diet, whether due to injury, disease, or otherwise, could use the present invention to aid in the feeding process. It could also be used for feeding or administering medicines to animals that tend to intake food and liquid by a suction action into their mouths.

Detailed descriptions of an exemplary embodiment is provided herein. It is to be understood, however, that the present invention may be embodied in various forms. Therefore, specific details disclosed herein are not to be interpreted as limiting, but rather as a basis for the claims presented herein, and as representative basis for teaching one skilled in the art to employ the present invention in virtually any appropriately detailed system, structure or manner.

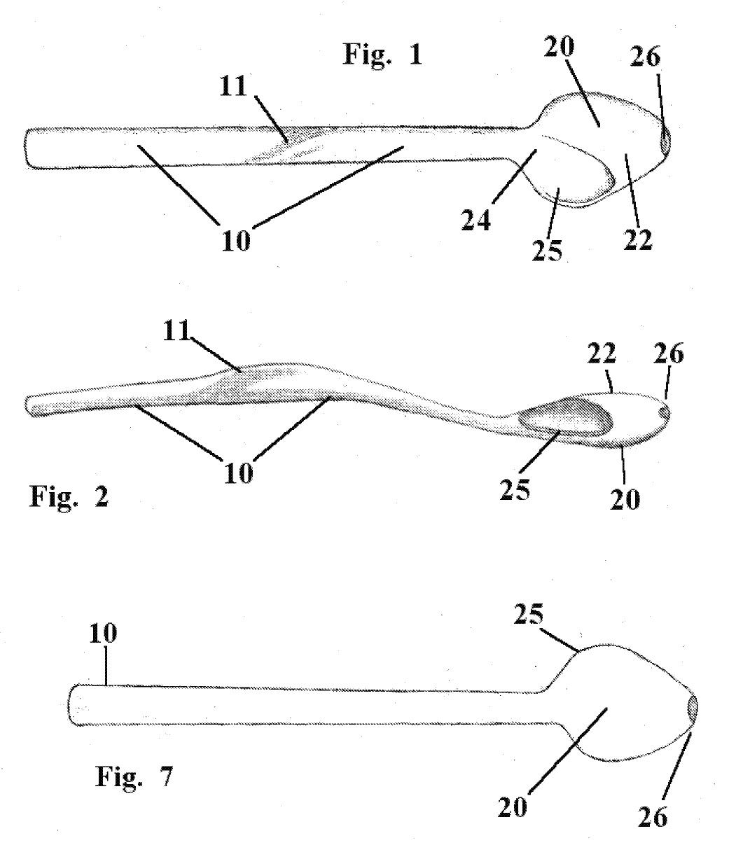

In FIG. 1, the utensil for use with the present invention is shown from a top view. The handle of the device (10) having a diagonal ridge (11) can be seen ending in the spoon bowl (20). The spoon bowl is partially covered with an enclosing shield (22), which is attached to the spoon bowl so that it leaves openings at the posterior of the bowl (24) and at the anterior of the bowl (26). The handle can be of various lengths directly related to the comfort and efficiency of the feeding process, and the spoon bowl can be made in varying sizes to accommodate different mouth sizes. The spoon edge at the posterior opening (25) is straightened to form a spatula-shape, allowing for easier collection of food into the bowl of the spoon.

FIG. 2 shows a side view of the utensil for use with the present invention with the enclosing shield (22) on the spoon bowl (20). In this view, the contour ridge (11) of the handle (10) is apparent. The handle may be contoured for ease in collection of the food and insertion of the spoon bowl into the infant's mouth. It may also have a coating of vinyl or other friction-inducing material that will enhance the grip of the person feeding the infant.

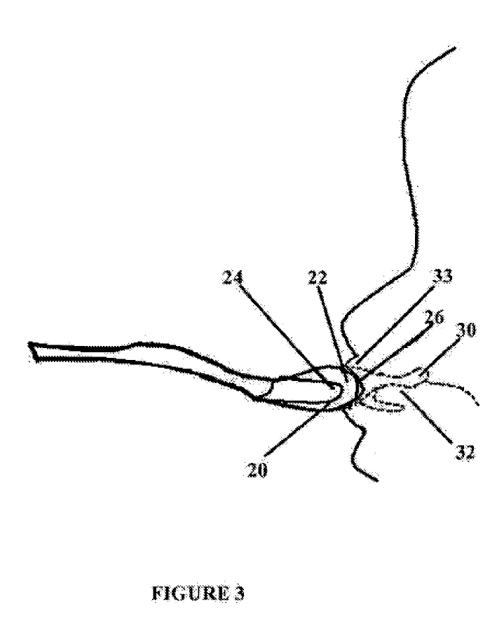

FIG. 3 shows an infant being fed from a side view. The infant's mouth cavity (30) and tongue (32) can be seen in the position common at the transitional feeding stage between bottle and spoon, pressing the spoon bowl (20) against the top of the mouth and creating suction to move the food into the mouth cavity. The lips of the infant (33) are seen to be in full circumferential contact with the spoon bowl (20) and the enclosing shield (22). The semi-liquid food was originally collected through the posterior opening in the spoon bowl (24) by moving the spoon bowl through ajar or other container of food so that the food enters the posterior opening of the bowl and is held within the bowl cavity formed by the spoon bowl and the enclosing shield. When the spoon is inserted into a child's mouth, the child can suction the food through the anterior opening of the bowl (26) and into the rear cavity of the child's mouth. The spoon is then removed from the child's mouth to allow for the natural swallowing reflex to be completed.

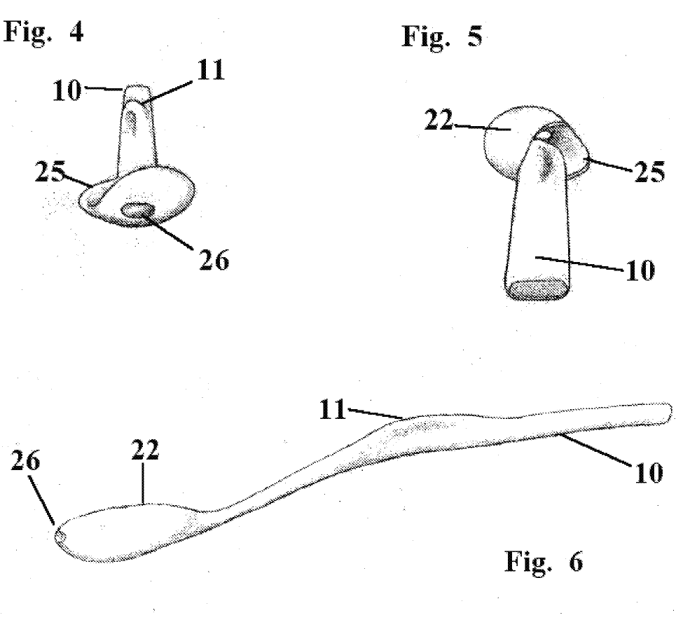

FIG. 4 shows the spoon from the point of view of the person being fed.

FIG. 5 shows the spoon from the point of view of the person doing the feeding.

FIG. 6 shows a side view of the spoon, from the opposite side as that shown in FIG. 2.

FIG. 7 shows a bottom view of the spoon.

1. A method for feeding a child with a spoon during a transition from bottle-to-spoon-feeding, the child having a mouth, the child having a natural swallowing reflex, the spoon having a handle, the spoon having a bowl, the bowl having an end away from the handle thus defining an anterior end, the bowl having an end toward the handle thus defining a posterior end, the method comprising the steps of:
covering a front portion of a spoon bowl by an enclosing shield so that that it leaves an opening at a posterior of the spoon bowl and at an anterior of the spoon bowl;
collecting a semi-liquid food through the posterior opening in the spoon bowl by moving the spoon bowl through a container of food so that the semi-liquid food enters the posterior opening of the spoon bowl and is held within a bowl cavity formed by the spoon bowl and the enclosing shield;
inserting the spoon into the child's mouth;
suctioning the semi-liquid food by the child through the anterior opening of the spoon bowl and into a rear cavity of the child's mouth; and
removing the spoon from the child's mouth to allow for the natural swallowing reflex to be completed.

2. The method of claim 1, wherein the enclosed chamber of the spoon bowl corresponds at its anterior end to the shape of a slightly depressed nipple, being ovoid in shape.

3. The method of claim 1, wherein the anterior opening of the spoon bowl is oval in shape and is smaller than the posterior opening of the bowl.

4. The method of claim 1, wherein the posterior opening of the spoon bowl is angled to allow for easier collection of the food, as compared with a spoon lacking the one, and where the posterior opening of the spoon bowl is larger than the anterior opening of the bowl.

5. The method of claim 1, wherein the shield is asymmetrical relative to the bowl to allow for an easy collection of the food into the enlarged side of the posterior opening.

6. The method of claim 1, wherein the underside shape of the spoon bowl corresponds to a conventional spoon shape except that the anterior of the bowl is more narrow and convex than a conventional spoon shape and the tip is a straight edge.

7. A method for reducing expulsion of food from a mouth of an infant transitioning from bottle to spoon feeding comprising the steps of:
drawing a spoon through food in a dish or jar,
said spoon having a handle, said spoon having a bowl, said bowl having a posterior end and an anterior end, said posterior end further defined as the end positioned closest to the handle of the spoon, said anterior end further defined as the end positioned closest to the mouth of the infant during feeding, said bowl being partially covered by an enclosing shield attached to the bowl, said enclosing shield being positioned in such as way as to create an opening at the posterior end of the bowl and an opening at the anterior end of the bowl;
collecting food through the opening at the posterior end of the bowl;
placing the anterior end of the bowl into the mouth of the infant;
providing full circumferential contact of the bowl of the spoon with the mouth of the infant, creating a seal around the opening at the anterior end of the bowl;
drawing, by the infant, the food from the bowl of the spoon through the opening at the anterior end of the bowl to the rear of the mouth of the infant;
removing the bowl of the spoon from the mouth of the infant.

8. The method of claim 7, performed at least three times in succession.

9. The method of claim 7, further characterized in that the handle of the spoon is contoured for ease in collection of the food and insertion of the spoon bowl into the mouth of the infant.

10. The method of claim 7, further characterized in that the handle of the spoon has a coating of vinyl or other friction-inducing material.
